(19) United States
(12) Patent Application Publication
(10) Pub. No.: US 2003/0130156 A1
(43) Pub. Date: Jul. 10, 2003

(54) Detergent compositions

(75) Inventors: Prasanna Rao Dontula, Vlaardingen (NL); Alyn James Parry, Merseyside (GB); Catherine Maria Powell, Merseyside (GB); Karen Robinson, Merseyside (GB); Wiebe Schokker, Vlaardingen (NL); Gilbert Martin Verschelling, Vlaardingen (NL); Pieter Broer van der Weg, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/273,132

(22) Filed: Oct. 17, 2002

(30) Foreign Application Priority Data
Oct. 19, 2001 (GB) 0125215.4

(51) Int. Cl. C11D 17/00

(52) U.S. Cl. 510/446; 510/509; 510/452

(57) ABSTRACT

A particulate laundry detergent composition which comprises, as separate particulate components:

(a) at least 10 wt % granular detergent base powder comprising surfactant and builder and having a bulk density of at least 0.5 kg/l, preferably at least 0.6 kg/l; and

(b) no more than 10 wt % particulate potassium carbonate,

wherein the potassium carbonate has a size/density index (SD) of no more than 400, preferably no more than 300, more preferably no more than 200, desirably no more than 100 and especially no more than 75, wherein SD=bulk density (kg/l)×d₅₀ particle size (microns). The potassium carbonate preferably has a d50 particle size of less than 300 microns, preferably less than 200 microns.

### TECHNICAL FIELD

The invention relates to particulate laundry detergent compositions with improved dispensing properties.

### BACKGROUND AND PRIOR ART

The problem of providing improved dispensing, dispersing and dissolving laundry detergent powders is well-known and has been addressed many times in the past. It is undesirable, for example, to have a slow dispensing powder which forms a residue in the drawer of many automatic washing machines. This problem is particularly acute when the detergent powder is a medium to high bulk density powder obtained by granulation rather than by spray drying.

It is known that potassium carbonate may be added to particulate detergent compositions.

EP 560 395 (Kao) discloses a particulate nonionic surfactant based detergent which may also contain an alkali-metal carbonate. Potassium carbonate is disclosed in general but sodium carbonate is preferred. There is no disclosure of particle sizes or bulk densities.

EP 578 871 (Procter & Gamble) discloses a particulate detergent base composition of narrow particle size distribution to which is added filler particles with a particle size of either less than 150 microns or greater than 1180 microns. The filler particles may be potassium carbonate. It teaches that unless the fine particles are removed from the base powder then the dispensing residues are poor.

### SUMMARY OF INVENTION

Surprisingly, the present inventors have found that specific grades of potassium carbonate, when added as a separate particulate ingredient (post-dosed) to an already formulated particulate detergent base composition, significantly improve the dispensing times of the whole detergent composition.

### STATEMENT OF INVENTION

In a first aspect, the present invention provides a particulate laundry detergent composition which comprises, as separate particulate components:

(a) at least 10 wt % granulated detergent base powder comprising surfactant and builder and having a bulk density of at least 0.5 kg/l; and

(b) no more than 10 wt % particulate potassium carbonate

wherein the potassium carbonate has a size/density index (SD) of no more than 400, wherein SD=bulk density (kg/l)×d₅₀ particle size (microns).

In a second aspect, the present invention provides a process for making a laundry detergent composition according to any preceding claim, which comprises the steps of:

(i) preparing a detergent base powder, comprising surfactant and builder, by granulation; followed by

(ii) dry-mixing particulate potassium carbonate with the base powder

wherein the potassium carbonate has a size/density index (SD) of no more than 400, wherein SD=bulk density (kg/l)×d₅₀ particle size (microns).

In a third aspect, the present invention provides the use of post-dosed potassium carbonate having a size/density index of less than 400 to improve dispensing times of particulate detergent compositions.

### DETAILED DESCRIPTION OF THE INVENTION

Definitions

“Bulk density” means the bulk density of the whole powder in the uncompacted aerated form.

“Granular base powder” is a powder characterised by substantial homogeneity, i.e. the composition of the individual granules is representative of the base powder as a whole. Granular base powders may be made by a high-speed mixer/granulator, and/or other non-spray drying processes such as fluid bed granulation. The compositions of the present invention may also comprise other base powders which may be made by spray-drying as well as by granulation, but for the purposes of the present invention these are not included within the term “granulated base powder”.

“Post-dosed” means materials which are not included in a base powder but are added separately to the base powder ‘post’ manufacture, generally by dry-mixing, and retain their separate identity within the final powder.

“d₅₀ particle size” is the weight median particle diameter, at which 50 wt % of the particles are greater than and 50 wt % of the particles are smaller than the d₅₀ particle size.

Potassium Carbonate

The potassium carbonate should dissolve rapidly and therefore has a size/density index (SD) of no more than 400, wherein SD=bulk density (kg/l)×d₅₀ particle size (microns). Preferably the size/density index is no more than 300, more preferably no more than 200, desirably no more than 100 and especially no more than 75.

When the potassium carbonate according to this requirement is added it is not necessary to add more than 10 wt %, leaving space for other detergent components. Preferably the composition comprises no more than 7 wt % particulate potassium carbonate, more preferably no more than 5 wt %. However preferably the composition comprises at least 1 wt % particulate potassium carbonate, preferably at least 1.5 wt % particulate potassium carbonate.

The potassium carbonate preferably has a bulk density of no more than 0.8 kg/l.

The potassium carbonate preferably has a d₅₀ particle size of at most 300 microns, preferably at most 200 microns.

Granular Base Powder

The detergent compositions of the present invention comprise a base powder obtained by granulation. As previously indicated, in addition to the granular base powder the compositions of the present invention may also comprise a spray-dried base powder. However, if this is the case then the detergent composition as a whole preferably comprises no more than 70 wt % spray dried base powder.

Compositions of the present invention comprise at least 10 wt % granular base powder, and preferably comprise from 20 to 90 wt % granular base powder.

The granular base powder comprises surfactant and builder and has a bulk density of at least 0.5 kg/l, preferably at least 0.6 kg/l.

Granular base powders may be prepared by mixing and granulating processes, for example, using a high-speed mixer/granulator, and/or other non-spray drying processes such as fluid bed granulation.

Potassium carbonate should be post-dosed to the base powder after it has been manufactured. This is preferably achieved by dry-mixing.

Detergent Ingredients

Detergent compositions according to the invention contain, as well as the alkali metal salt and the water-soluble organic acid, conventional detergent ingredients, notably detergent-active materials (surfactants), and preferably also detergency builders.

Laundry detergent compositions in accordance with the invention may suitably comprise from 5 to 60 wt % of detergent-active surfactant, from 10 to 80 wt % of detergency builder, and optionally other detergent ingredients to 100 wt %.

The detergent compositions will contain, as essential ingredients, one or more detergent active compounds (surfactants) which may be chosen from soap and non-soap anionic, cationic, nonionic, amphoteric and zwitterionic detergent active compounds, and mixtures thereof. Many suitable detergent active compounds are available and are fully described in the literature, for example, in “Surface-Active Agents and Detergents”, Volumes I and II, by Schwartz, Perry and Berch.

The preferred detergent active compounds that can be used are soaps and synthetic non-soap anionic and nonionic compounds. Non-soap anionic surfactants are especially preferred.

Non-soap anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Potassium salts are generally preferred. A preferred anionic surfactant is linear alkylbenzene sulphonate.

Nonionic surfactants may optionally be present. These include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpoly-glycosides, glycerol monoethers, and polyhydroxyamides (glucamide).

Cationic surfactants may optionally be present. These include quaternary ammonium salts of the general formula R₁R₂R₃R₄N³⁰ X⁻ wherein the R groups are long or short hydrocarbyl chains, typically alkyl, hydroxyalkyl or ethoxylated alkyl groups, and X is a solubilising anion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

In an especially preferred cationic surfactant of the general formula R₁R₂R₃R₄N⁺X⁻, R₁ represents a C₈-C₁₀ or C₁₂-C₁₄ alkyl group, R₂ and R₃ represent methyl groups, R₄ presents a hydroxyethyl group, and X⁻ represents a halide or methosulphate ion.

Optionally, amphoteric surfactants, for example, amine oxides, and zwitterionic surfactants, for example, betaines, may also be present.

Preferably, the quantity of anionic surfactant is in the range of from 3 to 50% by weight of the total composition. More preferably, the quantity of anionic surfactant is in the range of from 5 to 35 wt %, most preferably from 10 to 30 wt %.

Nonionic surfactant, if present, in addition to any which may be present as emulsifier in the speckles, is preferably used in an amount within the range of from 1 to 20 wt % in addition to that which may be present in the structured emulsion.

The total amount of surfactant present is preferably within the range of from 5 to 60 wt %.

The compositions may suitably contain from 10 to 80 wt %, preferably from 15 to 70 wt %, of detergency builder. Preferably, the quantity of builder is in the range of from 15 to 50 wt %.

The detergent compositions may contain as builder a crystalline aluminosilicate, preferably an alkali metal aluminosilicate, more preferably a sodium aluminosilicate (zeolite).

The zeolite used as a builder may be the commercially available zeolite A (zeolite 4A) now widely used in laundry detergent powders. Alternatively, the zeolite may be maximum aluminium zeolite P (zeolite MAP) as described and claimed in EP 384 070B (Unilever), and commercially available as Doucil (Trade Mark) A24 from Crosfield Chemicals Ltd, UK.

Zeolite MAP is defined as an alkali metal aluminosilicate of zeolite P type having a silicon to aluminium ratio not exceeding 1.33, preferably within the range of from 0.90 to 1.33, preferably within the range of from 0.90 to 1.20.

Especially preferred is zeolite MAP having a silicon to aluminium ratio not exceeding 1.07, more preferably about 1.00. The particle size of the zeolite is not critical. Zeolite A or zeolite MAP of any suitable particle size may be used.

Also preferred according to the present invention are phosphate builders, especially sodium tripolyphosphate.

This may be used in combination with sodium orthophosphate, and/or sodium pyrophosphate.

Other inorganic builders that may be present additionally or alternatively include sodium carbonate, layered silicate, amorphous aluminosilicates.

Most preferably, the builder is selected from sodium tripolyphosphate, zeolite, sodium carbonate, and combinations thereof. Organic builders may optionally be present. These include polycarboxylate polymers such as polyacrylates and acrylic/maleic copolymers; polyaspartates; monomeric polycarboxylates such as citrates, gluconates, oxydisuccinates, glycerol mono-di- and trisuccinates, carboxymethyloxysuccinates, carboxy-methyloxymalonates, dipicolinates, hydroxyethyl iminodiacetates, alkyl- and alkenylmalonates and succinates; and sulphonated fatty acid salts.

Organic builders may be used in minor amounts as supplements to inorganic builders such as phosphates and zeolites. Especially preferred supplementary organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Detergent compositions according to the invention may also suitably contain a bleach system, although non-bleaching formulations are also within the scope of the invention.

The bleach system is preferably based on peroxy bleach compounds, for example, inorganic persalts or organic peroxyacids, capable of yielding hydrogen peroxide in aqueous solution. Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %.

Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED).

A bleach stabiliser (heavy metal sequestrant) may also be present. Suitable bleach stabilisers include ethylenediamine tetraacetate (EDTA) and the polyphosphonates such as Dequest (Trade Mark), EDTMP.

The detergent compositions may also contain one or more enzymes. Suitable enzymes include the proteases, amylases, cellulases, oxidases, peroxidases and lipases usable for incorporation in detergent compositions.

Preferred proteolytic enzymes (proteases) are catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available. Proteases of both high and low isoelectric point are suitable.

Other enzymes that may suitably be present include lipases, amylases, and cellulases including high-activity cellulases such as Carezyme (Trade Mark) ex Novo.

In particulate detergent compositions, detergency enzymes are commonly employed in granular form in amounts of from about 0.1 to about 3.0 wt %. However, any suitable physical form of enzyme may be used in any effective amount.

Antiredeposition agents, for example, cellulose esters and ethers, for example sodium carboxymethyl cellulose, may also be present.

The compositions may also contain soil release polymers, for example sulphonated and unsulphonated PET/POET polymers, both end-capped and non-end-capped, and polyethylene glycol/polyvinyl alcohol graft copolymers such as Sokolan (Trade Mark) HP22.

Especially preferred soil release polymers are the sulphonated non-end-capped polyesters described and claimed in WO 95 32997A (Rhodia Chimie).

The detergent compositions may also include one or more inorganic salts other than builder salts. These may include, for example, sodium bicarbonate, sodium silicate, sodium sulphate, magnesium sulphate, calcium sulphate, calcium chloride and sodium chloride. Preferred inorganic salts are sodium sulphate, sodium chloride, and combinations thereof.

The detergent compositions may also contain other inorganic materials, for example, calcite, silica, amorphous aluminosilicate, or clays.

Other ingredients that may be present include solvents, hydrotropes, fluorescers, dyes, photobleaches, foam boosters or foam controllers (antifoams) as appropriate, fabric conditioning compounds, and perfumes.

Process for the Manufacture of the Detergent Compositions

The granular base powder component may be made as described above. If the composition also comprises a spray-dried base powder, then this is made by conventional spray-drying a slurry of the base detergent ingredients.

The potassium carbonate and the other post-dosed ingredients are then added to the base powder or a mixture of more than one base powder. This may be achieved by any convenient method depending on the ingredient to be added. For example potassium carbonate is dry-mixed with the base powder. Likewise liquid ingredients, if required, may be sprayed onto the powder.

### EXAMPLES

Grades of Potassium Carbonate

The following grades of potassium carbonate were used. Granular sodium carbonate was used as a comparative material.

| Grade of | | | |
|---|---|---|---|
| potassium | | Bulk density | |
| carbonate | d₅₀ (microns) | (kg/l) | SD Index |
| Grade 1 | 137 | 0.905 | 123 |
| Grade 2 | 413 | 0.900 | 372 |
| Granular sodium | 431 | 1.050 | 452 |
| carbonate | | | |

Dispensing Test Protocol

For the purposes of the present invention, dispensing is assessed by means of a standard procedure using a test rig based on the main wash compartment of the dispenser drawer of the Philips (Trade Mark) AFG washing machine. This drawer design provides an especially stringent test of dispensing characteristics especially when used under conditions of low temperature, low water pressure and low rate of water flow.

The drawer is of generally cuboidal shape and consists of three larger compartments, plus a small front compartment and a separate compartment for fabric conditioner. Only the middle (main wash) compartment is used in the test, the other compartments play no part in the test.

In the plate above the drawer an area has been cut away without affecting the spray holes, to allow visual inspection of the dispensing process.

In the test, a 100 g dose of powder is placed in a heap at the front end of the main compartment of the drawer, and subjected to a controlled water fill rate of 5 litres/minute at 10° C. The water enters through 2 mm diameter holes in a plate above the drawer: some water enters the front compartment and therefore does not reach the powder. Powder and water in principle leave the drawer at the rear end which is open.

The dispensing of the powder is followed visually and the time at which all the powder is dispensed is recorded. After the maximum dispensing time (in most cases set at 1 minute) the flow of water is ceased, and any powder remaining is then collected and dried at 95° C. to constant weight. The dry weight of powder recovered from the dispenser drawer, in grams, represents the weight percentage of powder not dispensed into the machine (the residue). Every result is the average of two duplicate measurements. Total dispensing is followed up to 60 seconds.

### Examples 1 to 6 and Comparative Examples A to D

Powder Formulations

A detergent base powder was made by granulation in a high speed mixer, a moderate speed mixer and a fluid bed as described in WO 00 77147 and to the formulation according to Table 1. The base powder had a bulk density of 0.85 kg/l.

Using this base powder, a number of formulations were made up comprising various levels of potassium carbonate in a range of grades.

TABLE 1

| Ingredient | Wt % |
|---|---|
| Sodium LAS | 14.2 |
| Alcohol ethoxylate, 6.5 EO | 11.6 |
| Tallow soap | 2.6 |
| Zeolite MAP | 46.5 |
| Sodium carbonate | 15.6 |
| Sodium carboxymethyl cellulose | 0.9 |
| Moisture + salts | 8.6 |

The powder formulations and the results of the test are given in Table 2.

TABLE 2

| | Example | | | | | | | | | |
|---|---|---|---|---|---|---|---|---|---|---|
| Component | A | B | C | D | 1 | 2 | 3 | 4 | 5 | 6 |
| Base Powder | 98 | 96 | 94 | 90 | 98 | 96 | 94 | 98 | 96 | 94 |
| ‘dense’ sodium carbonate | 2 | 4 | 6 | 10 | — | — | — | — | — | — |
| (d₅₀ = 431 μm) (SD = 452) | | | | | | | | | | |
| Potassium carbonate grade 2 | — | — | — | — | 2 | 4 | 6 | — | — | — |
| (d₅₀ = 413 μm) (SD = 372) | | | | | | | | | | |
| Potassium carbonate grade 1 | — | — | — | — | — | — | — | 2 | 4 | 6 |
| (d₅₀ = 137 μm) (SD = 123) | | | | | | | | | | |
| Dispensing time (seconds) | >60 | >60 | >60 | 38 | 35 | 21 | 23 | 34 | 21 | 13 |
| Residue after 60 seconds | 15.4% | 6.2% | 1.6% | — | — | — | — | — | — | — |
| (wt %) | | | | | | | | | | |

### Examples 7 and 8 and Comparative Examples E and F

Full detergent compositions were prepared using two base powders, one made by a non-tower granulation process, given in Table 3, and the other from a spray-drying process, given in Table 4.

TABLE 3
Composition of Granular Base Powder 1

| Ingredient | Wt % |
|---|---|
| Sodium LAS | 15.4 |
| Alcohol-ethoxylate 7EO | 12.0 |
| Tallow soap | 1.7 |
| Zeolite MAP (100%) | 39.5 |
| Sodium Carbonate | 12.9 |
| Sodium carboxy methyl cellulose | 0.8 |
| (68% active) | |
| Sodium sulphate | 9.7 |
| Moisture + salts | 8.0 |
| Bulk Density (kg/l) | 0.78 ± 0.05 |

TABLE 4
Composition of Spray-dried Base Powder 2

| Ingredient | Wt % |
|---|---|
| Sodium LAS | 9.2 |
| Alcohol-ethoxylate NI-7EO | 6.9 |
| Soap | 2.0 |
| Zeolite MAP (100%) | 24.0 |
| Acrylic/maleic co-Polymer (100%) | 3.0 |
| Sodium carbonate | 18.3 |
| Sodium silicate | 1.9 |
| Sodium sulphate | 27.0 |
| Minors, moisture + salts | 7.7 |
| Bulk Density (kg/l) | 0.40 ± 0.05 |

Potassium carbonate and other post-dosed ingredients were added to the base powders. The final formulations and their dispensing times are given in Table 5.

TABLE 5

| Ingredient | E | F | 7 | 8 |
|---|---|---|---|---|
| Base powder 1 | 30.22 | 30.22 | 30.22 | 30.22 |
| Base powder 2 | 42.45 | 42.45 | 42.45 | 42.45 |
| Fluorescer granule (15%) | 0.81 | 0.81 | 0.81 | 0.81 |
| Antifoam granule | 1.25 | 1.25 | 1.25 | 1.25 |
| Dequest 2016D | 0.41 | 0.41 | 0.41 | 0.41 |
| Dequest 2047 | 0.73 | 0.73 | 0.73 | 0.73 |
| TAED 83% | 2.64 | 2.64 | 2.64 | 2.64 |
| Na-Percarbonate | 15.24 | 15.24 | 15.24 | 15.24 |
| Dense sodiumcarbonate | 2.60 | 1.60 | — | — |
| Potassium carbonate (grade 1) | 0.00 | 1.00 | 2.60 | 5.00 |
| Carbonate/disilicate | 3.66 | 3.66 | 3.66 | 1.26 |
| cogranule | | | | |
| Dispensing time (seconds) | 58 | 58 | 26 | 23 |

We claim:

1. A particulate laundry detergent composition which comprises, as separate particulate components:
(a) at least 10 wt % granular detergent base powder comprising surfactant and builder and having a bulk density of at least 0.5 kg/l; and
(b) no more than 10 wt % particulate potassium carbonate,
wherein the potassium carbonate has a size/density index (SD) of no more than 400, wherein SD=bulk density (kg/l)×d₅₀ particle size (microns).

2. A composition as claimed in claim 1, which comprises from 20 to 90 wt % granular detergent base powder.

3. A composition as claimed in claim 1, wherein the granular detergent base powder has a bulk density of at least 0.6 kg/l.

4. A composition as claimed in claim 1, which comprises no more than 70 wt % spray dried base powder.

5. A composition as claimed in claim 1, which comprises no more than 7 wt % particulate potassium carbonate.

6. A composition as claimed in claim 5, which comprises no more than 5 wt % particulate potassium carbonate.

7. A composition as claimed in claim 1, which comprises at least 1 wt % particulate potassium carbonate.

8. A composition as claimed in claim 7, which comprises at least 1.5 wt % particulate potassium carbonate.

9. A composition as claimed in claim 1, wherein the size/density index is no more than 300.

10. A composition as claimed in claim 9, wherein the size/density index is no more than 200.

11. A composition as claimed in claim 10, wherein the size/density index is no more than 100.

12. A composition as claimed in claim 11, wherein the size/density index is no more than 75.

13. A composition as claimed in claim 1, wherein the potassium carbonate has an average bulk density of at most 0.8 kg/l.

14. A composition as claimed in claim 1, wherein the potassium carbonate has a d₅₀ particle size of at most 300 microns.

15. A composition as claimed in claim 14, wherein the potassium carbonate has a d₅₀ particle size of at most 200 microns.

16. A process for making a laundry detergent composition according to any preceding claim, which comprises the steps of:
(i) preparing a detergent base powder, comprising surfactant and builder, by granulation; followed by
(ii) dry-mixing particulate potassium carbonate with the base powder
wherein the potassium carbonate has a size/density index (SD) of no more than 400, wherein SD=bulk density (kg/l)×d₅₀ particle size (microns).
